(19) United States
(12) Patent Application Publication
(10) Pub. No.: US 2021/0042050 A1
(43) Pub. Date: Feb. 11, 2021

(54) METHOD AND APPARATUS FOR REBUILDING MEMORY MAPPING TABLES

(71) Applicant: Goke US Research Laboratory, Santa Clara, CA (US)

(72) Inventors: Steven Schauer, Loveland, CO (US); Engling Yeo, San Jose, CA (US)

(73) Assignee: Goke US Research Laboratory

(21) Appl. No.: 16/537,430

(22) Filed: Aug. 9, 2019

(51) Int. Cl. G06F 3/06; G06F 12/10; G06F 12/0804

(52) U.S. Cl. CPC G06F 3/0647; G06F 3/0611; G06F 3/0659; G06F 2212/205; G06F 12/10; G06F 12/0804; G06F 2212/1032; G06F 3/068

(57) ABSTRACT

A method and apparatus for reducing the time for rebuilding a memory mapping table in a host computer. A memory mapping table is maintained by a host computer in dynamic memory and duplicated in a data storage device, for example, a solid state drive (SSD). If power is lost, a rebuild engine inside the data storage device separate and apart from a controller CPU rebuilds the memory mapping table in the dynamic memory based on a copy of the memory mapping table maintained by the data storage device.

### BACKGROUND

### I. Field of Use

The present invention relates to the field of computer data storage and more specifically to memory management.

### II. Description of the Related Art

Increasingly, computers are using non-volatile Solid-State Devices (SSDs) to store large amounts of data. These SSDs typically utilize NAND flash memory, arranged in banks and channels. Firmware implemented in SSDs, typically referred to as a Flash Translation Layer or FTL, allows host operating systems to access the flash memory in a similar manner as accessing conventional hard disk drives. The FTL is commonly executed by a “controller” in the SSD, which comprises an embedded processor, an EEPROM for storing the FTL and other firmware, Error Correction Code (ECC) circuitry, a flash component interface (such as the Open NAND Flash Interface (ONFI)), and a host electrical interface (such as SATA, USB, SAS, NVMe, a or combination). The FTL plays a key role in terms of performing data address mapping, garbage collection and wear leveling.

Mapping tables are used in SSDs to allow data from host systems to be combined and stored as a unit, commonly referred to as a page (referring to DRAM memory in a host) or a block (referring to flash memory in an SSD). Mapping tables improve memory write performance by allowing blocks of the flash memory to be filled sequentially.

In the SSD, one or more memory mapping tables are stored in a volatile memory, and a duplicate copy of each memory mapping table is stored in a non-volatile flash memory array. During normal operation, as data is written to the SSD, the mapping table(s) stored in the volatile memory are updated, but the duplicate copies of the mapping tables in the non-volatile flash memory array is/are only updated periodically, for example, during lulls in the SSD I/O. Generally, only updates are provided to the memory mapping tables stored in the non-volatile flash memory, rather than re-writing the entire contents. Updating the mapping table(s) in the SSD in this way ensures that updates are small, fast and frequent, so that regular I/O performed of the SSD is not impacted, and only small sections of the mapping table 9s) are at risk of loss if, for example, power to the SSD is lost unexpectedly.

After a power failure, upon power up, the mapping table(s) stored in the SSD is/are re-created, or “rebuild”, in the volatile memory from the copy/copies stored in the non-volatile flash memory. This process is performed, in large part, by the SSD controller CPU, consuming a large number of controller CPU resources. After the mapping table(s) has/have been re-created in the volatile memory, it/they are generally updated to ensure that any data written to the SSD during the time that the mapping table(s) was/were being re-created is identified and updated.

The mapping table re-creation process described above may take anywhere between several seconds and tens of seconds, representing an undesirable characteristic for SSDs. This process additionally consumes valuable SSD controller CPU resources, which slows data I/O between the SSD and a host computer. It would be desirable, therefore, to speed up the mapping table re-creation process so that the I/O function of the SSD is not impaired.

### SUMMARY

The embodiments herein describe a method and apparatus for reducing a time to rebuild one or more memory mapping tables upon reboot after a power failure has occurred. In one embodiment, a data storage device (SSD) is described, comprising a volatile memory for storing the memory mapping table, a non-volatile storage array for storing data from a host computer and for storing a copy of the memory mapping table, a CPU memory for storing first processor-executable instructions, a controller CPU, coupled to the non-volatile storage array, the volatile memory and the CPU memory, for executing the first processor-executable instructions that cause the SSD to read and write the data as instructed by the host computer, and a rebuild engine coupled to the controller CPU and the non-volatile storage array, the rebuild engine comprising a rebuild engine memory for storing second processor-executable instructions that causes the rebuild engine to rebuild the memory mapping table in the volatile memory upon receipt of an instruction from the controller CPU to rebuild the memory mapping table.

In another embodiment, a method, performed by a data storage device is described, comprising generating, by a controller CPU, an instruction for a rebuild engine coupled to the controller CPU to rebuild a memory mapping table from a copy of the memory mapping table stored in a non-volatile storage array coupled to the rebuild engine and the controller CPU, providing, by the controller CPU, the instruction to rebuild engine, and in response to receiving the instruction from the controller CPU, rebuilding, by the rebuild engine, the memory mapping table.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 illustrates a functional block diagram of one embodiment of a networked computer system comprising one or more data storage devices using the inventive concepts described herein;

FIG. 2 illustrates a functional block diagram of one embodiment of a computer comprising a data storage device using the inventive concepts described herein;

FIG. 3 is a simplified functional block diagram of a data storage device as shown in FIGS. 1 and 2, using the inventive concepts described herein;

FIG. 4 is a block diagram showing a conceptual relationship among a system lookup table (SLT), a global mapping table (GMT) and a non-volatile storage array that stores the SLT and GMT; and

FIGS. 5A-5D illustrate a flow diagram of one embodiment of a method performed by the data storage device as shown in FIG. 3 to reduce a time needed to rebuild a memory mapping table.

### DETAILED DESCRIPTION

The present disclosure describes an apparatus and method for rebuilding memory mapping tables in data storage devices, such as solid state hard drives (SSDs). Memory mapping tables comprise lookup tables that are used to convert virtual memory addresses, typically provided by a host computer, into physical addresses where data is stored in an SSD. A special “rebuild engine” is used to retrieve the memory mapping table, or tables, from a non-volatile flash memory array, where it/they are stored in a volatile memory for use by a controller CPU to perform read and write functions, as directed by a host computer. Offloading the task of reading the memory mapping table(s) to the rebuild engine allows the controller CPU to recover much more quickly from power failures than prior art SSDs.

While the embodiments of the invention are described herein in reference to an SSD, it should be understood that the concepts described could be applied to other types of devices, and not just storage devices or, in particular, SSDs, but to any electronic device that utilizes memory mapping tables. For example, the concepts described herein could be implemented into a digital camera, a computer, or a phone.

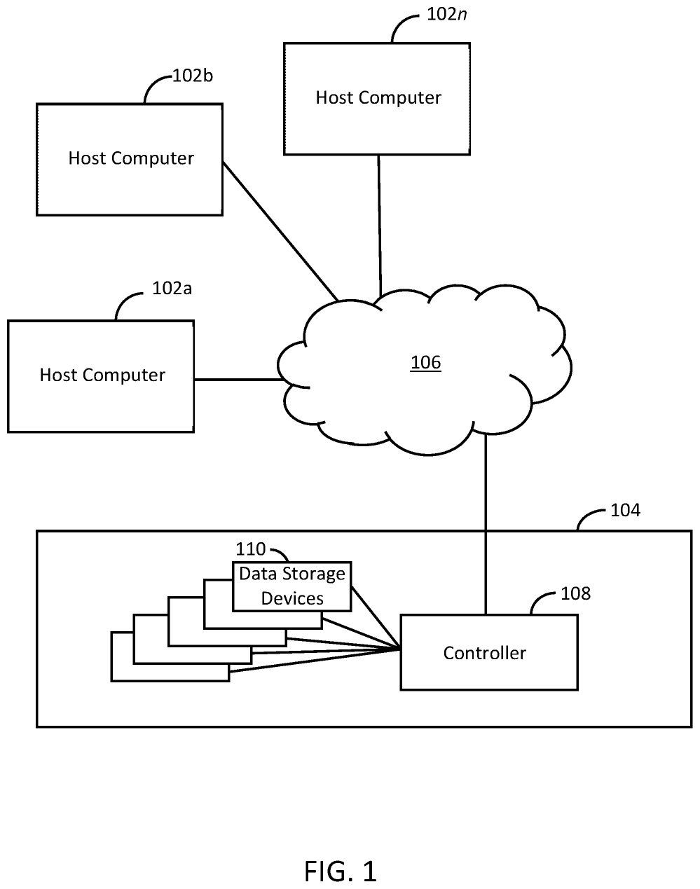

FIG. 1 illustrates a block diagram of one embodiment of a network-based, data storage system 100 in accordance with the teachings herein, comprising one or more host computers 102a-n coupled to data storage center 104 via wide-area network 106. Data storage center 104, in turn, comprises a controller 108 and one or more data storage devices 110, in one embodiment, one or more SSDs for storing data from the host computer(s). The host computer(s) 102 typically store and retrieve data in data storage center 104 by providing a virtual address, for example a logical block address (LBA) with each read or write command. One of the SSDs receives the virtual addresses as directed by controller 108 and maps it to a physical address of a non-volatile data storage array, typically flash memory, within the SSD.

In one embodiment, each SSD maintains two memory mapping tables that each comprise a lookup table that map virtual addresses of read and write commands from a host computer to physical addresses in a non-volatile storage array. A first memory mapping table is referred to herein as a system lookup table (SLT) that is updated each time that a new virtual-to-physical mapping occurs. A second memory mapping table is referred to herein as global mapping table (GMT) that is updated periodically, typically during lulls in I/O, with the contents of the SLT. Both the SLT and the GMT are stored in a volatile memory of the SSD, and a copy of each of the SLT and GMT is also maintained in the non-volatile storage array and updated periodically in case of a power failure of the SSD. In the event of a power failure, both the SLT and GMT are copied into the non-volatile storage array before power is completely lost. Upon power-up, both the SLT and GMT are re-created, or “rebuilt” in the volatile memory from the copies of each stored in the non-volatile storage array. As the SLT is typically several times smaller than the GMT, the SLT is rebuild quickly, on the order of milliseconds, and then the GMT is rebuilt, generally requiring a much longer time to rebuild, on the order of seconds, tens of seconds or even minutes. As the GMT is being rebuilt (or after the GMT has been rebuilt), the contents of the GMT is checked against the SLT to ensure that the GMT is up-to-date. Rebuilding of the SLT and GMT is performed by a specialized “rebuild engine” inside an SSD, rather than a controller CPU, as will be explained in later detail herein.

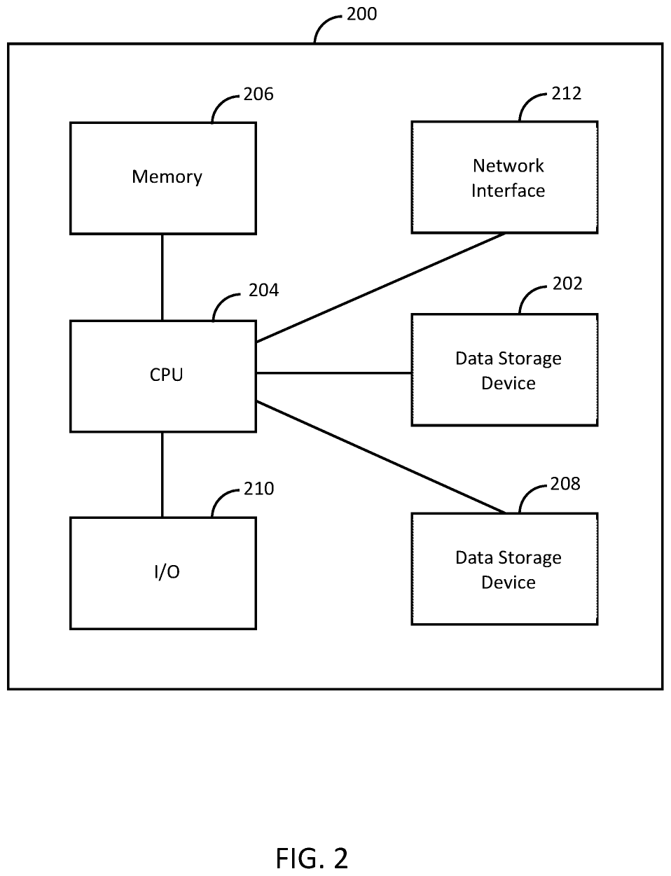

FIG. 2 illustrates a simplified functional block diagram of a computer 200 that utilizes SSD 202 as its non-volatile storage device, also in accordance with the teachings herein. In this embodiment, computer 200 comprises a CPU 204 for executing processor-executable instructions stored in a non-volatile memory 206 for general computing purposes, a volatile memory 208 for storing executable instructions relating to different programs executed by CPU 204, an I/O device 210 such as a touchscreen, keyboard, mouse, monitor, etc., and, typically, a network interface 212 for connection to the Internet. As in the embodiment described in FIG. 1, CPU 204 stores and retrieves data in SSD 202 by providing a logical block address (LBA) with each read or write command, which may then be converted into an intermediate logical allocation address (LAA), and then mapped by SSD 202 into a physical allocation address (PAA) of a non-volatile data storage array, typically flash memory, within the SSD. The conversion of the LBA into an LAA is typically dependent upon the size of data corresponding to the LBA and the size of data corresponding to the PAA. For example, for each LBA provided by CPU 204, the read or write data associated with the LBA could be, for example, 1 kilobits in size. However, the PAA may reference 4 kilobits of data. So, conversion of an LBA into an LAA may comprise dividing the LBA by 4, and using the remainder as an identification of a portion of a PAA. Thus an LBA=1 references the 1^{st} ¼ of data referenced by a first PAA, an LBA=2 references the 2^{nd} ¼ of data referenced by the PAA, an LBA=3 references the 3^{rd} ¼ of data referenced by the PAA, and an LBA=4 references the 4^{th} ¼ of data referenced by the PAA.

An SLT and a GMT is maintained in volatile memory 208, as well as a copy of each table in SSD 202 and updated as described above with respect to the description of FIG. 1. Upon power-up after a power failure, both the SLT and GMT are rebuilt in volatile memory 208 from the copies of each stored in SSD 202 by a specialized rebuild engine, as described above with respect to the description of FIG. 1.

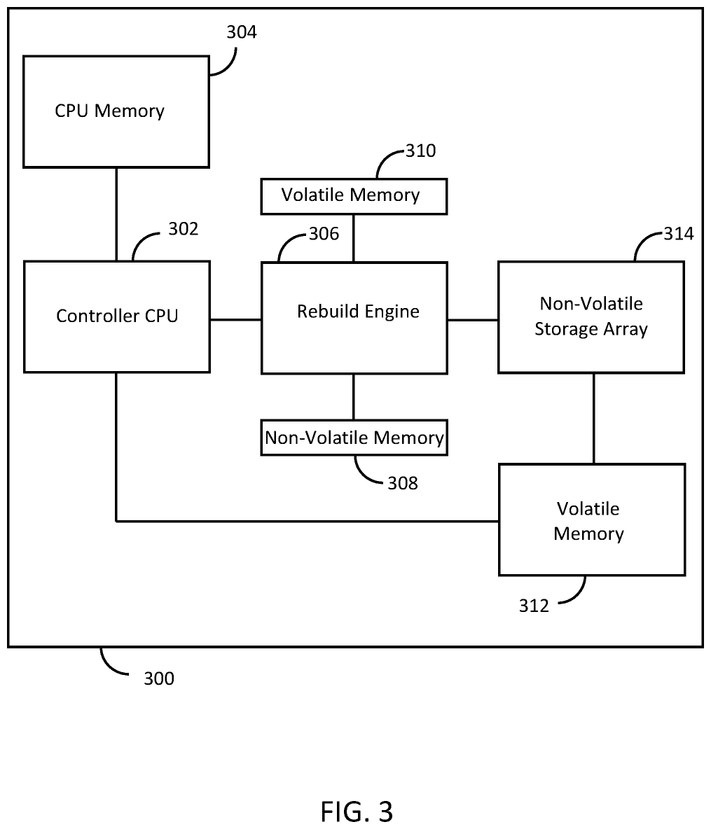

FIG. 3 is a simplified functional block diagram of a data storage device 300 that may be used in either of the embodiments described above, using the inventive concepts described herein. Shown is controller CPU 302, CPU memory 304, rebuild engine 306, non-volatile rebuild engine memory 308, volatile rebuild engine memory 310, SSD volatile memory 312, and non-volatile storage array 314. It should be understood that the functional components shown in FIG. 1 could be coupled to one another in a number of different arrangements, and that some functional blocks have been omitted for clarity in order to focus on the blocks needed for implementation of this embodiment of the invention, such as a host interface for communicating with a host computer or processor, one or more cache memories, etc.

Controller CPU 302 is configured to provide general operation of data storage device 300 by executing processor-executable instructions stored in CPU memory 304, for example, executable computer code. Controller CPU 302 comprises one or more microprocessors, microcontrollers, custom ASICs, PGAs, and/or similar circuitry, and/or supporting, peripheral circuitry, to execute the processor-executable instructions stored in memory 202. The microprocessors, microcontrollers, custom ASICs, and/or PGAs, are selected based on factors such as computational speed, cost, size, and other factors.

CPU memory 304 comprises one or more non-volatile information storage devices, such as ROM, flash memory, or other non-volatile type of electronic, optical, or mechanical memory device. CPU memory 304 is used to store the processor-executable instructions for operation of data storage device 300, including instructions that cause CPU 302 to generate commands to rebuild engine 306 for rebuild engine 306 to rebuild SLT 400 and GMT 402 and, in some embodiments, to respond to signals provided by rebuild engine 306. In one embodiment, at least a portion of the processor-executable instructions define a Flash Translation Layer, which are instructions that manages data flow to and from non-volatile storage array 314 during read and write operations. It should be understood that in some embodiments, CPU memory 304 is incorporated into controller CPU 302 and, further, that CPU memory 304 excludes media for propagating signals.

Rebuild engine 306 comprises one or more microprocessors, microcontrollers, custom ASICs, PGAs, and/or similar circuitry, and/or supporting, peripheral circuitry, to execute processor-executable instructions stored in non-volatile rebuild engine memory 308 specifically for rebuilding SLT 400 and GMT 402. In one embodiment, rebuilding the memory mapping tables is rebuild engine 306's only function. The microprocessors, microcontrollers, custom ASICs, and/or PGAs, are selected based on factors such as computational speed, cost, size, and other factors.

Non-volatile rebuild engine memory 308 comprises one or more non-volatile information storage devices, such as ROM, flash memory, or other type of non-volatile electronic, optical, or mechanical memory device. Non-volatile rebuild engine memory 308 is used to store the processor-executable instructions that cause rebuild engine 306 to rebuild the memory mapping tables. It should be understood that in some embodiments, non-volatile rebuild engine memory 308 is incorporated into rebuild engine 306 and, further, that non-volatile rebuild engine memory 308 excludes media for propagating signals.

Volatile rebuild engine memory 310 comprises one or more volatile information storage devices (i.e., stored data is lost upon loss of power), such as RAM, DRAM, SRAM, SDRAM, SDR SDRAM, DDR RAM, or other type of volatile electronic, optical, or mechanical memory device. In one embodiment, volatile rebuild engine memory 310 is used to store information from controller CPU 302, such as one or more “rebuild lists” that specify where in non-volatile storage array 314 to retrieve portions of SLT 400a and GMT 402a for rebuilding SLT 400 and GMT 402 in SSD volatile memory 312.

SSD volatile memory 312 comprises one or more volatile information storage devices (i.e., stored data is lost upon loss of power), such as RAM, DRAM, SRAM, SDRAM, SDR SDRAM, DDR RAM, or other type of volatile electronic, optical, or mechanical memory device. SSD volatile memory 312 is used to store SLT 400 and GMT 402 as initially created by controller CPU 302 or rebuilt by rebuild engine 306, among other information used in I/O operations performed by controller CPU 302.

non-volatile storage array 314 comprise one or more non-transitory information storage devices, such as flash memory, or some other type of non-volatile, electronic, optical, or mechanical memory device, used to store large amounts of data from a host computer. A portion of non-volatile storage array 314 is used to store copies of SLT 402 and GMT 404 as updated by controller CPU periodically. In one embodiment, non-volatile storage array 314 comprises a number of NAND flash memory chips, arranged in a series of physical banks, channels and/or planes, to provide multiple terabytes of data storage. Non-volatile storage array 314 excludes media for propagating signals.

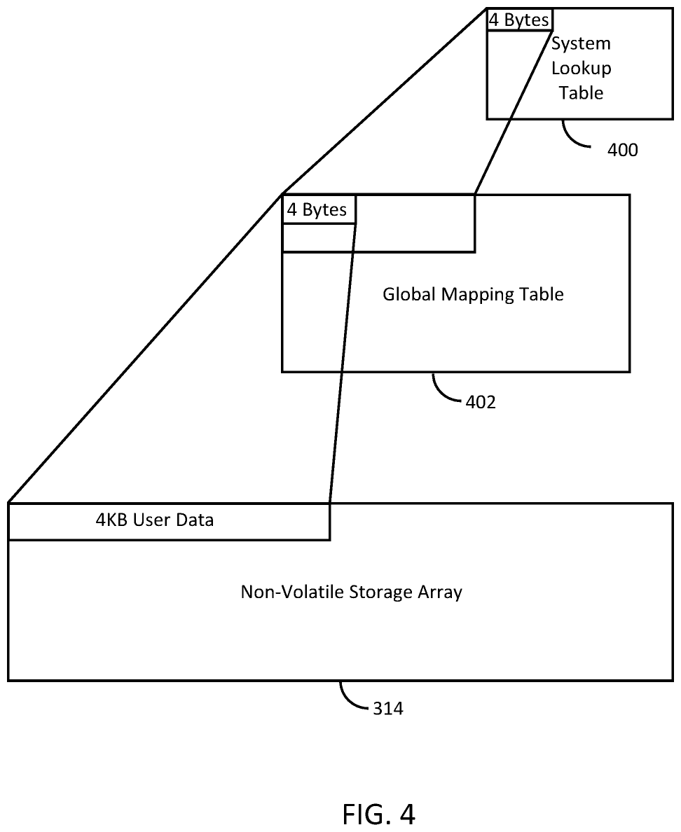

As mentioned previously, in one embodiment, an SLT and a GMT are both stored in SSD volatile memory 312, and controller CPU 302 initially creates and stores these tables in SSD volatile memory 312. FIG. 4 shows a conceptual relationship between an SLT 400, GMT 402 and non-volatile storage array 314: in this embodiment, each four bytes of data in SLT 400 indexes 4 KB of data in GMT 402, and, also in this embodiment, four bytes of data in GMT 402 indexes the physical address of 4 KB of user data (i.e., data from a host computer) stored in non-volatile storage array 314. In this example, data storage device 300 comprises a 32 Terabyte SSD, GMT 402 is 32 Gigabytes in size, and SLT 400 is 32 Megabytes in size. The size of SLT 400 and GMT 402 is generally proportional to the size of non-volatile storage array 314, with GMT 402 containing a number of entries to address “chunks” or “pages” of data stored by non-volatile storage array 314, and SLT 400 containing a number of entries to address “chunks” or “pages” of entries of GMT 402.

SLT 400 is stored within SSD volatile memory 312, comprising a plurality of entries, each entry comprising updated memory mapping information (i.e., a mapping between an LBA or an LAA and a physical address in non-volatile storage array 314), the updated memory mapping information generated by controller CPU 302 while processing write commands from a host computer before GMT 402 has been rebuilt into SSD volatile memory 312 (updated memory mapping information may also result from controller CPU 302 performing garbage collection or consolidation tasks), the memory mapping information comprising a virtual address (either an LBA or an LAA) and a corresponding physical address where the virtual address is mapped in non-volatile storage array 314. As each write command is received, controller CPU 302 determines a physical address (i.e., a page address and an offset value) within non-volatile storage array 314 where to store the data, as known in the art, and then updates SLT 200 with a mapping between the virtual address provided by the host computer and the physical address determined by controller CPU 302.

GMT 402 is stored within SSD volatile memory 312, comprising a plurality of entries, each entry comprising memory mapping information comprising a virtual address (either an LBA or an LAA) provided by the host computer and a corresponding physical address where the virtual address is mapped in non-volatile storage array 314. GMT 402 is updated periodically by controller CPU 302 with the information in SLT 400, and then SLT 400 is cleared.

A copy of SLT 400 and GMT 402, referred to herein as SLT 400a and SLT 400b, is stored in non-volatile storage array 314 at addresses known by controller CPU 302. The copies are updated periodically by controller CPU 302, typically by providing only information that has changed over a predetermined time period, or the update is performed based on the number of updates that have been written to SLT 400. If a power failure occurs with SSD, or a host computer where SSD is located, controller CPU 302 updates the copies in non-volatile storage array 314 before data storage device 300 becomes non-operational. Both SLT 400 and GMT 402 are lost during a power failure, due to the volatile nature of SSD volatile memory 312.

When power is restored, controller CPU 302 provides an indication to rebuild engine 306 for rebuild engine 306 to rebuild, or re-create, SLT 400 in SSD volatile memory 312 from SLT 400a that has been stored in non-volatile storage array 314. In one embodiment, the indication generated by controller CPU 302 comprises a “rebuild list” comprising a list of logical allocation addresses (LAAs), each LLA identifying a “source” address in non-volatile storage array 314 of SLT 400a where each entry of SLT 400a may be found. Rebuild engine 306, in turn, begins rebuilding SLT 400 in SSD volatile memory 312 by converting the LLA in each entry of the rebuild list into a physical allocation address (PAA) of non-volatile storage array 314, the PAA comprising one or more of a page, an offset, a bank, a plane, block, channel, row, and/or column, as well as others. Each entry in the rebuild list typically also comprises a respective destination address identifying an address in SSD non-volatile memory 312 where to store the data retrieved from non-volatile storage array 314, and, in some embodiments, a length of the mapping information contained in each entry of GMT 402a. The rebuild engine then generates, in one embodiment, a DMA read command, where the PAA and the destination address are loaded into temporary registers of rebuild engine 306 and issues the read command to non-volatile storage array 314. In some embodiments, an entire portion, block or page is read in a DMA burst mode initiated by rebuild engine 306.

Non-volatile storage array 314 receives the read command and retrieves an entry in non-volatile storage array 314 corresponding to the read command, using the PAA and destination address stored in the rebuild engine temporary register, the entry comprising a virtual address provided by the host computer (either an LBA or an LAA) and a physical address of a page of GMT 402 where the virtual address is mapped in non-volatile storage array 314. This process is repeated for each entry in the rebuild list, where the PAA and destination address are incremented based on the length of the mapping information. At the conclusion of processing, SLT 400a is rebuilt in SSD volatile memory 312.

Next, controller CPU 302 issues a command for rebuild engine to rebuild GMT 402 in SSD volatile memory 312 from GMT 402a that has been stored in non-volatile storage array 314. In one embodiment, the command generated by controller CPU 302 comprises a second rebuild list comprising a second list of logical allocation addresses (LAAs) that identify source address, corresponding destination addresses, and a length of each mapping information stored in each GMT 402a entry. The LLA identifies a source address in non-volatile storage array 314 of GMT 402a where each entry of GMT 402a may be found, and the destination address identifies a location in SSD volatile memory 312 where entry should be stored. In one embodiment, for any entry in SLT 400 (or 400a), (indicating that a change has been made to the mapping of a particular virtual address either before GMT 402a could be updated just before a loss of power, or during the time needed to rebuild GMT 402a), controller CPU generates an entry in the rebuild list that identifies an LAA in non-volatile storage array 314 that points to an entry in the SLT 400a, rather than to an entry in GMT 402a where the “old” mapping data is stored. In this way, the rebuild list contains some entries pointing to GMT 402a in non-volatile storage array 314, where mapping data has not been changed, and other entries pointing to SLT 400a in non-volatile storage array 314, for any GMT mapping data that did change.

After the second rebuild list has been generated, it is provided by controller CPU 302 to rebuild engine 306, which begins rebuilding GMT 402 in SSD volatile memory 312 by converting the LLA in each entry of the second rebuild list into a physical allocation address (PAA) of non-volatile storage array 314, the PAA comprising one or more of a page, an offset, a bank, a plane, block, channel, row, and/or column, as well as others. The rebuild engine then generates, in one embodiment, a DMA read command comprising the PAA and issues the read command to non-volatile storage array 314.

Non-volatile storage array 314 receives the read command and retrieves an entry in non-volatile storage array 314 corresponding to the PAA, the entry comprising memory mapping information, comprising one or more of a virtual address and a corresponding physical address where the virtual address is mapped in non-volatile storage array 314. This process is repeated for each entry in the second rebuild list. At the conclusion of processing. GMT 402a is rebuilt in SSD volatile memory 312. Using rebuild engine 306, controller CPU is free to perform other important functions, such as processing read and write commands from the host computer.

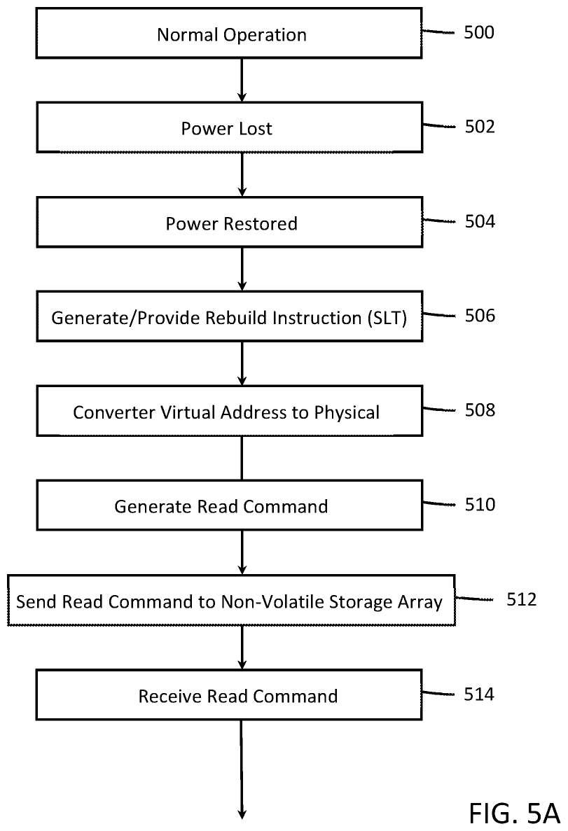

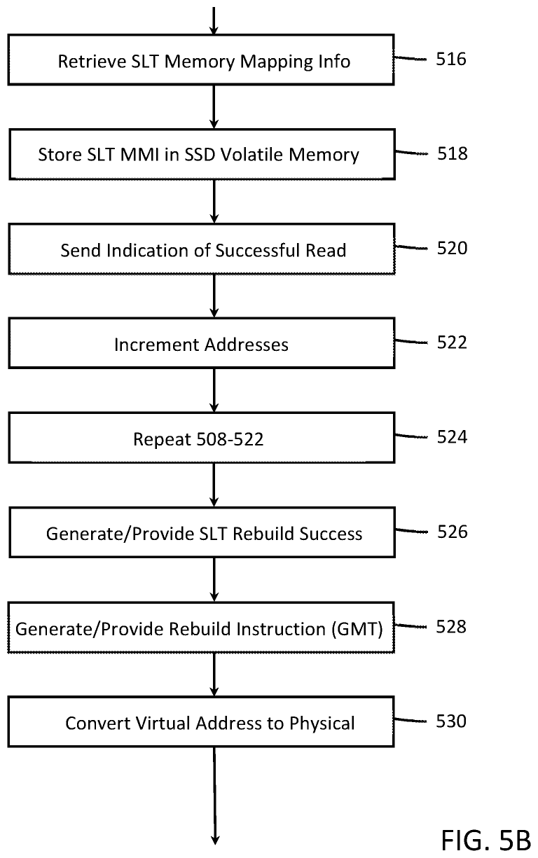

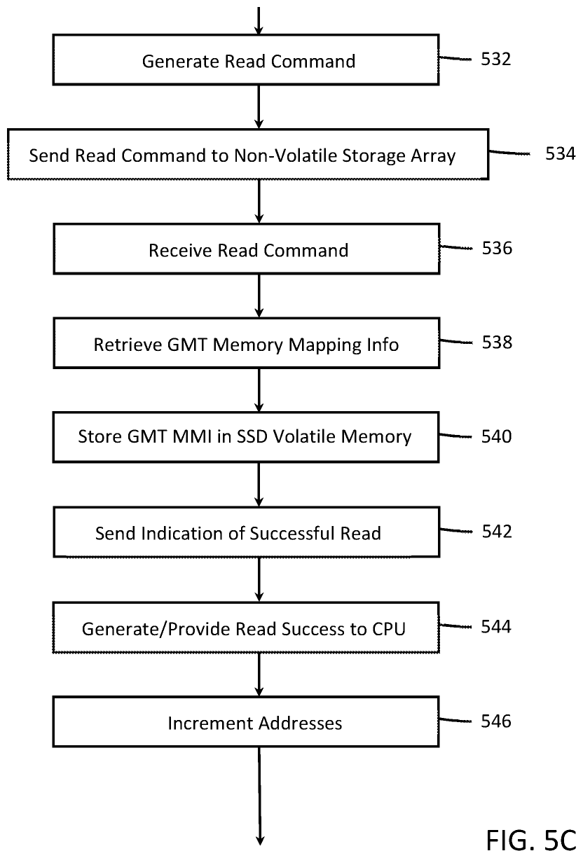

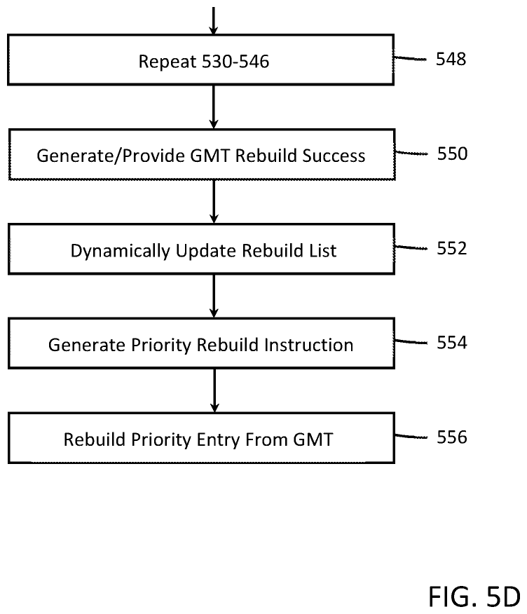

FIG. 5 is a flow diagram illustrating one embodiment of a method performed by data storage device 300, and specifically controller CPU 302 and rebuild engine 306, to rebuild at least one memory map in SSD volatile memory 312 by executing processor-executable instructions stored in CPU memory 304 and non-volatile rebuild engine memory 308, respectively. It should be understood that although the method shown in FIG. 5 describes a particular embodiment where an SLT and a GMT are rebuilt, in other embodiments, a different number of type of memory mapping table(s) may be rebuilt in the alternative. It should further be understood that in some embodiments, not all of the steps shown in FIG. 5 are performed and that the order in which the steps are carried out may be different in other embodiments. It should be further understood that some minor method steps have been omitted for purposes of clarity.

At block 500, data storage device 300 is operating normally, storing and retrieving data for one or more host computers. During normal operations, controller CPU 312 initially creates SLT 400 and GMT 402 and stores them in SSD volatile memory 312, as known in the art. Controller CPU 302 may store address information of SLT 400a and GMT 402a in CPU memory 304, such as a starting address, and ending address, a length or size (in bits or byes) of the data associated with each entry, and/or a size of each of SLT 400a or GMT 403a. Controller CPU 302 additionally creates a copy of SLT 400 and GMT 402 and stores them in non-volatile storage array 314 as SLT 400a and 400b at addresses in non-volatile storage array 314 that are stored in CPU memory 304 (or a range of addresses are stored). In one embodiment, controller CPU may provide addressing information of SLT 400a and GMT 402a to rebuild engine 306, either additionally or alternatively, and rebuild engine 306 stores the addressing information in non-volatile rebuild engine memory 308 for use in rebuilding SLT 400 and GMT 402 in SSD volatile memory 312 in the event of an unexpected power failure.

Further during normal operations, controller CPU 302 processes read and write requests from the one or more host computers. For write requests, controller CPU 302 receives a portion of data from a host computer and an associated LBA assigned by the host computer to store the data portion in data storage device 300. In one embodiment, controller CPU converts the LBA into a logical allocation address (LAA), using the size of data referenced by the LBA vs. the size of date referenced by each physical allocation address (PAA) where data is physically stored on non-volatile storage array 314. Controller CPU 302 stores the data portion at the PAA, and then stores a mapping of the LAA (or LBA) address to the PAA as an entry in SLT 400 in SSD volatile memory 312. Controller CPU 302 periodically updates the mapping information of entries in SLT 400a with updated mapping information in SLT 400, and further updates GMT 402, stored in SSD volatile memory 312, and GMT 402a, stored in non-volatile storage array 314, based on updated mapping information in SLT 400. Once GMT 402 and GMT 402a is updated, SLT 400 and SLT 402a may be cleared by controller CPU 302.

At block 502, power is lost by data storage device 300 due to, for example, powering down a computer by a user, an unexpected loss of power at a facility where SSD is located, etc.

At block 504, power is restored to data storage device 300.

At block 506, as a result of power being restored to data storage device 300, controller CPU generates and provides an instruction to rebuild engine 306 for rebuild engine 306 to rebuild SLT 400 in SSD volatile memory 312. In one embodiment, the instruction comprises information for rebuild engine 306 to locate SLT 400a in non-volatile storage array 314, such as a starting logical allocation address (LAA), or LBA, and a size of SLT 400a, a starting LAA/LBA and an ending LAA/LBA of SLT 400a, or an ending LAA/LBA and a size of SLT 400a. In another embodiment, the instruction comprises a “rebuild list” comprising a list of LAAs/LBAs within non-volatile storage array 314 where each entry of SLT 400a is located, a corresponding destination address for each entry, and a length of each entry in GMT 402a. For example, if SLT 400a comprises an array of 32 bits by 1,048,576 (i.e., 2²⁰) entries, the rebuild list may comprise a list of 1,048,576 entries, each entry comprising an address in non-volatile storage array 314 where to retrieve memory mapping information for that particular address, a corresponding destination address where to store the memory mapping information in SSD volatile memory 312, and a length of the memory mapping information.

In another embodiment, where source and destination addressing information and a length of each memory mapping information that was previously stored by rebuild engine 306 in non-volatile engine rebuild memory 308, the instruction comprises simply an indication to rebuild engine 306 for rebuild engine 306 to rebuild SLT 400. Since rebuild engine 306 knows where to find SLT 400a in non-volatile storage array 314, and where to store the memory mapping information for each entry, based on the addressing information stored in non-volatile rebuild engine memory 308, there is no need, in this embodiment, for the instruction to comprise addressing information, as in the previous embodiment.

At block 508, rebuild engine 306 may convert a first address of the rebuild list or addressing information stored in non-volatile rebuild engine memory 308 into a physical address of non-volatile storage array 314. In one embodiment, an LAA is converted into a physical allocation address (PAA), the physical allocation address comprising one or more of a page number and an offset. In other embodiments, either alternatively or in addition, the PAA comprises one or more of a plane, a bank, block, channel, row, and/or column, as well as others.

At block 510, rebuild engine 306 generates a read command comprising an instruction to read memory mapping information from a portion of non-volatile storage array 314 corresponding to the physical address. In one embodiment, rebuild engine 306 stores the physical address and destination address into one or more temporary registers of the rebuild engine 306 and the read command comprises a direct memory access (DMA) read command. In another embodiment, the read command comprises the physical address and the destination address.

At block 512, rebuild engine 306 provides the read command to non-volatile storage array 314.

At block 514, the read command is received by non-volatile storage array 314.

At block 516, non-volatile storage array 314 retrieves memory mapping information stored at the physical address as indicated by rebuild engine 306, either by retrieving the physical address from one or more of the temporary registers of rebuild engine 306 or by determining the physical address from the read command, in an embodiment where the read command comprises the physical address.

At block 518, non-volatile storage array 314 stores the memory mapping information at the destination in SSD volatile memory 312 as indicated by rebuild engine 306, either by retrieving the destination address from one or more of the temporary registers of rebuild engine 306 or by determining the destination address from the read command, in an embodiment where the read command comprises the destination address.

At block 520, after non-volatile storage array 314 has stored the memory mapping information at the destination address in SSD volatile memory 312, non-volatile storage array 314 typically sends a signal to rebuild engine 306, indicating that the read command was successful, i.e., that the memory mapping information was successfully stored in the destination address of SSD volatile memory 312.

At block 522, in one embodiment, rebuild engine 306 increments the LAA and the destination address. In another embodiment, rebuild engine 306 loads the next LAA and the next destination address into the registers as provided in the rebuild list.

At block 524, blocks 508 through 522 are repeated, causing the entire SLT 400 to be rebuilt in SSD volatile memory 312. This process typically takes on the order of tens to hundreds of milliseconds.

At block 526, rebuild engine 306 may generate a signal indicating that SLT 400 has been rebuilt in SSD volatile memory 312, and provide the signal to controller CPU 302.

At block 528, at some time after receipt of the signal indicating that SLT 400 has been rebuilt, controller CPU 302 generates a command to cause rebuild engine 306 to rebuild GMT 402 in SSD volatile memory 312. As before, the read command may comprise a rebuild list comprising a source and destination address of each entry of GMT 402a and a length of the memory mapping information stored in each GMT entry, or just a starting (or ending) source address, an ending source address (or the number of entries in the GMT) and a length of the memory mapping information stored in each GMT entry.

In one embodiment, where the read command comprises a rebuild list, the rebuild list may comprise only entries from SLT 400a stored in non-volatile storage array 342 (or entries from SLT 400 stored in SSD volatile memory 312). Thus, if, for example, SLT 400a comprises three entries as a result of memory mapping changes from 3 write commands, the rebuild list would comprise an identification of the 3 addresses in SLT 400a that point to the updated memory mapping information. In this embodiment, controller CPU 302 provides rebuild engine with the rebuild list as well as addressing information of GMT 402a. Then, rebuild engine 306 rebuilds GMT 402a into SSD volatile memory 312 by sequentially reading memory mapping information from non-volatile storage array 314 as indicated by the GMT addressing information, but stores memory mapping information from SLT 400a when the rebuild list indicates that mapping information pertaining to a particular source address of GMT 400a has been changed. Thus, when rebuild engine 306 generates a read command based on an SLT entry, rebuild engine 306 places a source and destination address of one of the entries of SLT 400a (or SLT 400) into a register, and then non-volatile storage array 314 retrieves memory mapping information for that entry from SLT 400a (or SLT 400). In this way, rebuild engine 306 rebuilds GMT 402 using the memory mapping information stored in GMT 402a, but uses updated memory mapping information in SLT 400a (or SLT 400) when the rebuild list indicates that a change has been made to an entry in GMT 402a.

At block 530, rebuild engine 306 may convert a first address of the rebuild list or addressing information stored in non-volatile rebuild engine memory 308 into a physical address of non-volatile storage array 314. In one embodiment, an LAA is converted into a physical allocation address (PAA), the physical allocation address comprising one or more of a page number and an offset. In other embodiments, either alternatively or in addition, the PAA comprises one or more of a plane, a bank, block, channel, row, and/or column, as well as others.

At block 532, rebuild engine 306 generates a read command comprising an instruction to read memory mapping information from a portion of non-volatile storage array 314 corresponding to the physical address, whether the physical address points to an entry in GMT 402a or SLT 400a. In one embodiment, rebuild engine 306 stores the physical address and destination address into one or more temporary registers of the rebuild engine 306 and the read command comprises a direct memory access (DMA) read command. In another embodiment, the read command comprises the physical address and the destination address and, in some embodiments, a length of the memory mapping information.

At block 534, rebuild engine 306 provides the read command to non-volatile storage array 314.

At block 536, the read command is received by non-volatile storage array 314.

At block 538, non-volatile storage array 314 retrieves memory mapping information stored at the physical address as indicated by rebuild engine 306, either by retrieving the physical address from one or more of the temporary registers of rebuild engine 306 or by determining the physical address from the read command, in an embodiment where the read command comprises the physical address.

At block 540, non-volatile storage array 314 stores the memory mapping information at the destination in SSD volatile memory 312 as indicated by rebuild engine 306, either by retrieving the destination address from one or more of the temporary registers of rebuild engine 306 or by determining the destination address from the read command, in an embodiment where the read command comprises the destination address.

At block 542, after non-volatile storage array 314 has stored the memory mapping information at the destination address in SSD volatile memory 312, non-volatile storage array 314 typically sends a signal to rebuild engine 306, indicating that the read command was successful, i.e., that the memory mapping information was successfully stored in the destination address of SSD volatile memory 312.

At block 544, in one embodiment, in response to receiving the signal from non-volatile storage array 314, rebuild engine 306 generates an indication to indicate that a particular portion, or entry, of GMT 402a has been rebuilt, and provides the indication to controller CPU 302. Controller CPU 302 may be processing at least read commands immediately upon receiving such indication, because CPU 302 knows that the particular entry in GMT 402a is up to date.

At block 546, in one embodiment, rebuild engine 306 increments the LAA and the destination address. In another embodiment, rebuild engine 306 loads the next LAA and the next destination address into the registers as provided in the rebuild list.

At block 548, blocks 530 through 546 are repeated, causing the entire GMT 402 to be rebuilt in SSD volatile memory 312. Rebuilding GMT 402 takes on the order of seconds, tens of seconds, or even minutes depending on the storage capability of data storage device 300 and, therefore, GMT 400.

At block 550, rebuild engine 306 may generate a signal indicating that GMT 402 has been rebuilt in SSD volatile memory 312, and provide the signal to controller CPU 302.

At block 552, in one embodiment, the rebuild list provided from controller CPU 302 to rebuild engine 306 may be updated as GMT 402 is being rebuilt by rebuild engine 306. After controller CPU 302 has provided the command to rebuild GMT 402 but before receiving an indication that the rebuild has been completed, controller CPU 302 may provide addressing information to an entry in SLT 400, or SLT 400a, that has been changed during the rebuild of GMT 402. Rebuild engine 306, upon receipt of such an update, replaces or adds the information in the rebuild list so that when rebuild engine 306 performs a rebuild of the mapping information stored at the address provided by controller CPU in the update, rebuild engine will cause the memory mapping information stored at the address to be copied either from the source address in non-volatile storage array 314 (in the case where updates to SLT 400a occur as SLT 400 is changed), or from the source address in SSD volatile memory 312.

At block 554, in one embodiment, while controller rebuild engine 306 is rebuilding GMT 402, controller CPU 302 may generate a priority indication to rebuild engine 306 for rebuild engine 306 to rebuild a particular entry of GMT 402 before rebuilding other entries in response to receiving a request from a host computer to read data from data storage device 300. In this embodiment, controller CPU 302 may not know which portions of GMT 400 have been rebuilt while GMT 402 is being rebuilt, and in order to provide the correct read data to the host computer, controller CPU 302 may need to ensure that the correct mapping is up-to-date. In one embodiment, the priority indication comprises a source address that points to an entry in SLT 400 (or 400a), a destination address in SSD volatile memory 312 where to store the memory mapping information and a memory mapping information length.

At block 556, rebuild engine 302 receives the priority indication from controller CPU 302 and retrieves the memory mapping information from non-volatile storage array 314 from the source address as indicated in the priority indication. Then, rebuild engine 306 prioritizes rebuilding of the particular GMT 400 entry over rebuilding other entries of GMT 400, typically by processing the priority indication as soon as rebuild engine 306 finishes rebuilding a particular entry of GMT 400.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

We claim:

1. A data storage device, configured to reduce a time to rebuild a memory mapping table, comprising:
a volatile memory for storing the memory mapping table;
a non-volatile storage array for storing data from a host computer and for storing a copy of the memory mapping table;
a CPU memory for storing first processor-executable instructions;
a controller CPU, coupled to the non-volatile storage array, the volatile memory and the CPU memory, for executing the first processor-executable instructions that cause the SSD to read and write the data as instructed by the host computer; and
a rebuild engine coupled to the controller CPU and the non-volatile storage array, the rebuild engine comprising a rebuild engine memory for storing second processor-executable instructions that causes the rebuild engine to rebuild the memory mapping table in the volatile memory upon receipt of an instruction from the controller CPU to rebuild the memory mapping table.

2. The data storage device of claim 1, wherein the second processor-executable instructions that cause the memory mapping table to be rebuilt comprise instructions that causes the rebuild engine to:
receive the instruction from the controller CPU, the instruction comprising a first memory address where a first portion of the memory mapping table is stored in the non-volatile storage array and a second memory address in the volatile memory where the first portion of the memory mapping table should be stored in the volatile memory;
in response to receiving the instruction:
translate the first memory address into a physical address of the non-volatile storage array;
generate a read command associated with the first physical address and the second memory address;
provide the read command to the non-volatile storage array; and
receive a signal from the non-volatile storage array that the read command was successfully executed by the non-volatile storage array;
wherein the non-volatile storage array retrieves the first portion of the memory mapping table and provides the first portion to the volatile memory for storage in the volatile memory.

3. The data storage device of claim 2, wherein the second processor-executable instructions further comprise instructions that cause the rebuild engine to:
generate a second physical address where a second portion of the memory mapping table is stored;
generate a third memory address where to store the second portion of the memory mapping table in the volatile memory;
generate a second read command associated with the second physical address and the third memory address;
provide the second read command to the non-volatile storage array; and
receive a second signal from the non-volatile storage array that the second read command was successfully executed by the non-volatile storage array;
wherein the non-volatile storage array retrieves the second portion of the memory mapping table and provides the second portion to the volatile memory for storage in the volatile memory.

4. The data storage device of claim 1, wherein the second processor-executable instructions further comprise instructions that cause the rebuild engine to:
receive an instruction from the controller CPU to rebuild a second memory mapping table, the second memory mapping table indexed by the memory mapping table;
in response to receiving the instruction from the controller CPU, cause the second memory mapping table to be rebuilt in the volatile memory.

5. The data storage device of claim 4, wherein the second processor-executable instructions that cause the second memory mapping table to be rebuilt comprises instructions that causes the rebuild engine to:
receive the instruction, the instruction comprising a first memory address where a first portion of the second memory mapping table is stored in the non-volatile storage array and a second memory address in the volatile memory where the first portion of the second memory mapping table should be stored in the volatile memory;
translate the first memory address into a physical address of the non-volatile storage array;
generate a read command, the read command associated with the physical address and the second memory address;
provide the read command to the non-volatile storage array; and
receive a signal from the non-volatile storage array that the read command was successfully executed by the non-volatile storage array;
wherein the non-volatile storage array retrieves the first portion of the second memory mapping table and provides the first portion to the volatile memory for storage in the volatile memory.

6. The data storage device of claim 4, wherein the instruction comprises a rebuild list that identifies each portion of the second memory mapping table, and wherein the first processor-executable instructions comprise instructions that further causes the controller CPU to:
generate, by the controller CPU, the rebuild list, the rebuild list comprising a plurality of entries, each entry identifying a respective portion of the second memory mapping table, wherein a first entry of the rebuild list comprises a first virtual address and a physical address of the non-volatile storage array.

7. The data storage device of claim 6, wherein the first processor-executable instructions that causes the controller CPU to generate the rebuild list comprises instructions that causes the controller CPU to:
generate a second entry in the rebuild list, the second entry comprising a third address identifying a first portion in the first memory mapping table corresponding to a second portion of the second memory mapping table and a fourth address where the first portion of the second memory mapping table should be stored in the volatile memory.

8. The data storage device of claim 7, wherein the third address is inserted into the second entry by the controller CPU when the controller CPU determines that a memory mapping in the first portion has changed.

9. The data storage device of claim 4, wherein the second processor-executable instructions further comprise instructions that causes the rebuild engine to:
generate, by the rebuild engine, an indication that a particular portion of the second memory mapping table has been rebuilt; and
provide the indication to the controller CPU for use by the controller CPU to read or write data to or from the non-volatile storage array associated with the particular portion of the second memory mapping table that was rebuilt.

10. The data storage device of claim 4, wherein the second processor-executable instructions further comprise instructions that causes the rebuild engine to:
receive, by the rebuild engine from the controller CPU, an indication of a particular portion of the second memory mapping table to rebuild; and
prioritize, by the rebuild engine, rebuilding of the particular portion of the second memory mapping table over rebuilding other portions of the second memory mapping table.

11. A method performed by a data storage device to reduce a time to rebuild a memory mapping table, comprising:
generating, by a controller CPU, an instruction for a rebuild engine coupled to the controller CPU to rebuild a memory mapping table from a copy of the memory mapping table stored in a non-volatile storage array coupled to the rebuild engine and the controller CPU;
providing, by the controller CPU, the instruction to rebuild engine; and
in response to receiving the instruction from the controller CPU, rebuilding, by the rebuild engine, the memory mapping table.

12. The method of claim 11, wherein the instruction comprises a first memory address where a first portion of the memory mapping table is stored in the non-volatile storage array and a second memory address in the volatile memory where the first portion of the memory mapping table should be stored, and rebuilding the memory mapping table comprises:
translating, by the rebuild engine, the first memory address into a physical address of the non-volatile storage array;
generating, by the rebuild engine, a read command associated with the first physical address and the second memory address;
providing, by the rebuild engine, the read command to the non-volatile storage array;
in response to receiving the read command, retrieving, by the non-volatile storage array, the first portion of the memory mapping table from the non-volatile storage array;
providing, by the non-volatile storage array, the first portion to the volatile memory for storage in the volatile memory; and
sending, by the non-volatile storage array, a signal to the rebuild engine that the read command was successfully executed by the non-volatile storage array.

13. The method of claim 12, wherein rebuilding the memory mapping table comprises:
generating, by the rebuild engine, a second physical address where a second portion of the memory mapping table is stored;
generating, by the rebuild engine, a third memory address where to store the second portion of the memory mapping table in the volatile memory;
generating, by the rebuild engine, a second read command associated with the second physical address and the third memory address;
providing, by the rebuild engine, the second read command to the non-volatile storage array;
in response to receiving the second read command, retrieving, by the non-volatile storage array, the second portion of the memory mapping table from the non-volatile storage array;
providing, by the non-volatile storage array, the second portion to the volatile memory for storage in the volatile memory; and
sending, by the non-volatile storage array, a second signal to the rebuild engine that the second read command was successfully executed by the non-volatile storage array.

14. The method of claim 11, wherein rebuilding the memory mapping table comprises:
receiving, by the rebuild engine, an instruction from the controller CPU to rebuild a second memory mapping table, the second memory mapping table indexed by the memory mapping table;
in response to receiving the instruction from the controller CPU, causing, by the rebuild engine, the second memory mapping table to be rebuilt in the volatile memory.

15. The method of claim 14, wherein the instruction comprises a first memory address where a first portion of the second memory mapping table is stored in the non-volatile storage array and a second memory address in the volatile memory where the first portion of the second memory mapping table should be stored in the volatile memory, and causing the second memory mapping table to be rebuilt comprises:
translating, by the rebuild engine, the first memory address into a physical address of the non-volatile storage array;
generating, by the rebuild engine, a read command, the read command associated with the physical address and the second memory address;
providing the read command to the non-volatile storage array;
in response to receiving the read command, retrieving, by the non-volatile storage array, the first portion of the second memory mapping table from the non-volatile storage array;
providing, by the non-volatile storage array, the first portion of the second memory mapping table to the volatile memory for storage in the volatile memory; and
sending, by the non-volatile storage array, a signal to the rebuild engine that the read command was successfully executed by the non-volatile storage array.

16. The method of claim 14, wherein the instruction comprises a rebuild list, and generating the rebuild list by the controller CPU comprises:
generating, by the controller CPU, a plurality of entries, each entry identifying a respective portion of the second memory mapping table, wherein a first entry of the rebuild list comprises a first virtual address and a physical address of the non-volatile storage array.

17. The method of claim 16, wherein generating the rebuild list further comprises:
generating, by the controller CPU a second entry in the rebuild list, the second entry comprising a third address identifying a first portion in the first memory mapping table corresponding to a second portion of the second memory mapping table and a fourth address where the first portion of the second memory mapping table should be stored in the volatile memory.

18. The method of claim 17, wherein the third address is inserted into the second entry by the controller CPU when the controller CPU determines that a memory mapping in the first portion has changed.

19. The method of claim 14, further comprising:
generating, by the rebuild engine, an indication that a particular portion of the second memory mapping table has been rebuilt; and
providing, by the rebuild engine, the indication to the controller CPU for use by the controller CPU to read or write data to or from the non-volatile storage array associated with the particular portion of the second memory mapping table that was rebuilt.

20. The method of claim 14, further comprising:
receiving, by the rebuild engine from the controller CPU, an indication of a particular portion of the second memory mapping table to rebuild; and
prioritize, by the rebuild engine, rebuilding of the particular portion of the second memory mapping table over rebuilding other portions of the second memory mapping table.
